(19) United States
(12) Patent Application Publication
(10) Pub. No.: US 2015/0146037 A1
(43) Pub. Date: May 28, 2015

(54) IMAGING SYSTEMS WITH BROADBAND IMAGE PIXELS FOR GENERATING MONOCHROME AND COLOR IMAGES

(71) Applicant: Semiconductor Components Industries, LLC, Phoenix, AZ (US)

(72) Inventor: Brian Keelan, Boulder Creek, CA (US)

(21) Appl. No.: 14/089,064

(22) Filed: Nov. 25, 2013

(51) Int. Cl. H04N 9/73; H04N 9/43

(52) U.S. Cl. CPC H04N 9/735; H04N 9/43; H04N 2209/04
USPC 348/223.1

(57) ABSTRACT

An image sensor may have an array of image pixels that includes red image pixels that generate red image signals, blue image pixels that generate blue image signals, and broadband image pixels that generate broadband image signals in response to detecting at least two of red, blue, and green light. The image sensor may be operable in a monochrome imaging mode in which monochrome images are generated using the broadband signals and in a color imaging mode in which color images are generated using the red, green, and broadband signals. The image sensor may be coupled to processing circuitry that processes the image signals and that instructs the image sensor to perform imaging operations in either the monochrome imaging mode or the color imaging mode. The image sensor may be switched between the color imaging mode and the monochrome imaging mode autonomously and/or via input from a user.

### BACKGROUND

This relates generally to imaging devices, and more particularly, to imaging devices with broadband sensitive image pixels for performing color and monochrome imaging operations.

Image sensors are commonly used in electronic devices such as cellular telephones, cameras, and computers to capture images. In a typical arrangement, an electronic device is provided with an array of image pixels arranged in pixel rows and pixel columns. Circuitry is commonly coupled to each pixel column for reading out image signals from the image pixels.

Conventional imaging systems employ a single image sensor in which the visible light spectrum is sampled by red, green, and blue (RGB) image pixels arranged in a Bayer mosaic pattern. The Bayer Mosaic pattern consists of a repeating cell of two-by-two image pixels, with two green pixels diagonally opposite one another, and the other corners being red and blue.

In some cases, image sensors may be used to generate greyscale (monochrome) images. In conventional Bayer pattern image sensors, three separate demosaicking operations on red, green, and blue image signals and a subsequent weighted sum of demosaicked red, green, and blue, image signals are performed to generate greyscale images. However, generating images in this way can consume excessive power and processing resources in the image sensor, and the Bayer pattern does not readily enable further miniaturization of image sensors via smaller image pixel sizes because of limitations of signal to noise ratio (SNR) in the image signals captured from the image pixels.

It would therefore be desirable to be able to provide imaging devices with improved means of capturing and processing image signals.

### BRIEF DESCRIPTION OF THE DRAWINGS

FIG. 1 is a diagram of an illustrative electronic device having an image sensor and processing circuitry for generating color and monochrome images in accordance with an embodiment of the present invention.

FIG. 2 is a diagram of an illustrative pixel array and associated control circuitry for reading out pixel data from image pixels along column lines in an image sensor in accordance with an embodiment of the present invention.

FIG. 3 is a diagram of an illustrative pixel unit cell having broadband filter image pixels in accordance with an embodiment of the present invention.

FIG. 4 is a diagram of an illustrative imaging system having an image sensor with broadband filter image pixels and processing circuitry for generating color images and monochrome images in accordance with an embodiment of the present invention.

FIG. 5 is a flow chart of illustrative steps that may be performed by an imaging system of the type shown in FIGS. 1-4 for capturing monochrome image data and color image data using a pixel array having broadband filter image pixels in accordance with an embodiment of the present invention.

FIG. 6 is a flow chart of illustrative steps that may be performed by an imaging system for detecting motion in monochrome images and providing an alert to a user of the imaging system when motion is detected in the monochrome images in accordance with an embodiment of the present invention.

FIG. 7 is a flow chart of illustrative steps that may be performed by an imaging system for computing image statistics associated with monochrome images and autonomously switching between a monochrome imaging mode and a color imaging mode based on the image statistics in accordance with an embodiment of the present invention.

FIG. 8 is a block diagram of a processor system employing the embodiments of FIGS. 1-7 in accordance with an embodiment of the present invention.

### DETAILED DESCRIPTION

Electronic devices such as digital cameras, computers, cellular telephones, and other electronic devices may include image sensors that gather incoming light to capture an image. The image sensors may include arrays of image pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the image pixels and readout circuitry for reading out image signals corresponding to the electric charge generated by the photosensitive elements. Readout circuitry may include selectable readout circuitry coupled to each column of pixels that can be enabled or disabled to reduce power consumption in the device and improve pixel readout operations.

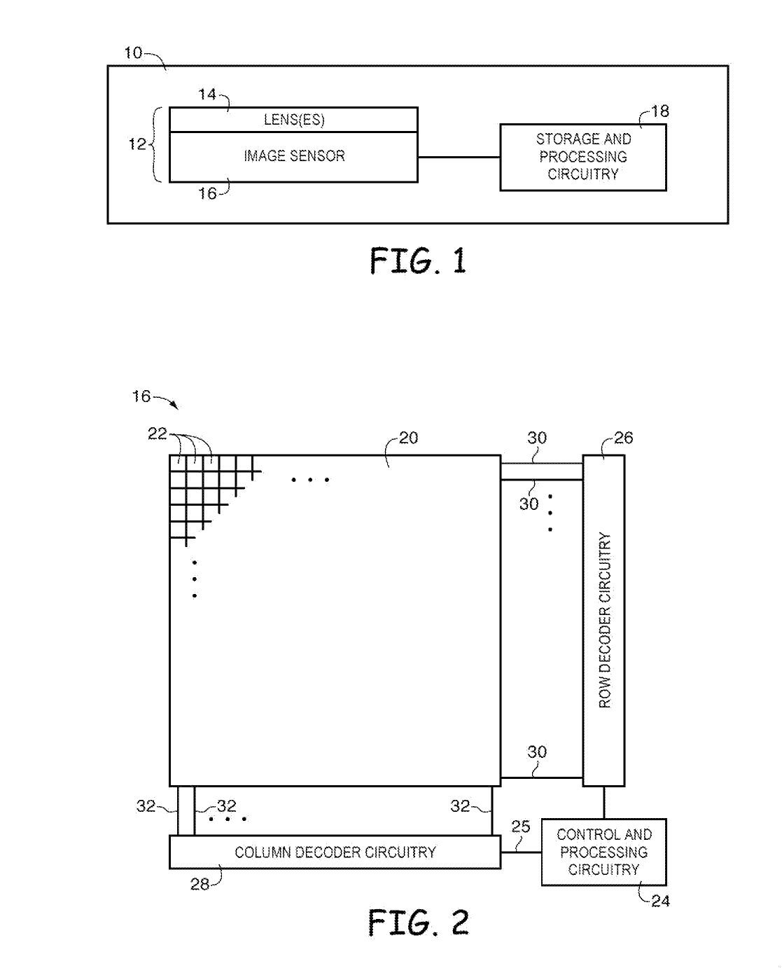

FIG. 1 is a diagram of an illustrative electronic device that uses an image sensor to capture images. Electronic device 10 of FIG. 1 may be a portable electronic device such as a camera, a cellular telephone, a tablet computer, a webcam, a video camera, a video surveillance system, a video gaming system with imaging capabilities, or any other desired imaging device that captures digital image data. Camera module 12 may be used to convert incoming light into digital image data. Camera module 12 may include one or more lenses 14 and one or more corresponding image sensors 16. During image capture operations, light from a scene may be focused onto image sensor 16 by lens 14. Image sensor 16 may include circuitry for converting analog pixel data into corresponding digital image data to be provided to storage and processing circuitry 18. If desired, camera module 12 may be provided with an array of lenses 14 and an array of corresponding image sensors 16.

Processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, external display, or other device) using wired and/or wireless communications paths coupled to processing circuitry 18.

As shown in FIG. 2, image sensor 16 may include a pixel array 20 containing image sensor pixels 22 (sometimes referred to herein as image pixels 22) and control and processing circuitry 24. Array 20 may contain, for example, hundreds or thousands of rows and columns of image sensor pixels 22. Control circuitry 24 may be coupled to row decoder circuitry 26 and column decoder circuitry 28. Row decoder circuitry 26 may receive row addresses from control circuitry 24 and supply corresponding row control signals such as reset, row-select, transfer, and read control signals to pixels 22 over control paths 30. One or more conductive lines such as column lines 32 may be coupled to each column of pixels 22 in array 20. Column lines 32 may be used for reading out image signals from pixels 22 and for supplying bias signals (e.g., bias currents or bias voltages) to pixels 22. During pixel readout operations, a pixel row in array 20 may be selected using row decoder circuitry 26 and image data associated with image pixels 22 in that pixel row can be read out along column lines 32.

Column decoder circuitry 28 may include sample-and-hold circuitry, amplifier circuitry, analog-to-digital conversion circuitry, bias circuitry, column memory, latch circuitry for selectively enabling or disabling the column circuitry, or other circuitry that is coupled to one or more columns of pixels in array 20 for operating pixels 22 and for reading out image signals from pixels 22. Readout circuitry such as signal processing circuitry associated with column decoder circuitry 28 (e.g., sample-and-hold circuitry and analog-to-digital conversion circuitry) may be used to supply digital image data to control and processing circuitry 24 and/or processor 18 (FIG. 1) over path 25 for pixels in chosen pixel columns.

Image sensor pixels such as image pixels 22 are conventionally provided with a color filter array which allows a single image sensor to sample red, green, and blue (RGB) light using corresponding red, green, and blue image sensor pixels arranged in a Bayer mosaic pattern. The Bayer mosaic pattern consists of a repeating unit cell of two-by-two image pixels, with two green image pixels diagonally opposite one another and adjacent to a red image pixel diagonally opposite to a blue image pixel. However, limitations of signal to noise ratio (SNR) that are associated with the Bayer Mosaic pattern make it difficult to reduce the size of image sensors such as image sensor 16.

If desired, image pixels 22 in array 20 of FIG. 2 may be provided with an array of color filter elements that each pass one or more colors of light. Color filter elements that pass two or more colors of light (e.g., two or more colors of light selected from the group that includes red light, blue light, and green light) are sometimes referred to herein as “broadband” filter elements. For example, yellow color filter elements that are configured to pass red and green light and clear color filter elements that are configured to pass red, green, and blue light may be referred to herein as broadband filter elements or broadband color filter elements. Similarly, image pixels that include a broadband color filter element (e.g., a yellow or clear color filter element) and that are therefore sensitive to two or more colors of light (e.g., that capture image signals in response to detecting two or more colors of light selected from the group that includes red light, blue light, and green light) may sometimes be referred to herein as broadband pixels or broadband image pixels. Broadband image pixels 22 may have a natural sensitivity defined by the material that forms the broadband color filter element and/or the material that forms the image sensor pixel (e.g., silicon). In another suitable arrangement, broadband image pixels 22 may be formed without any color filter elements. The sensitivity of broadband image pixels 22 may, if desired, be adjusted for better color reproduction and/or noise characteristics through use of light absorbers such as pigments. In contrast, “colored” pixel may be used herein to refer to image pixels that are primarily sensitive to one color of light (e.g., red light, blue light, green light, or light of any other suitable color). Colored pixels may sometimes be referred to herein as narrowband image pixels because the colored pixels have a narrower spectral response than the broadband image pixels.

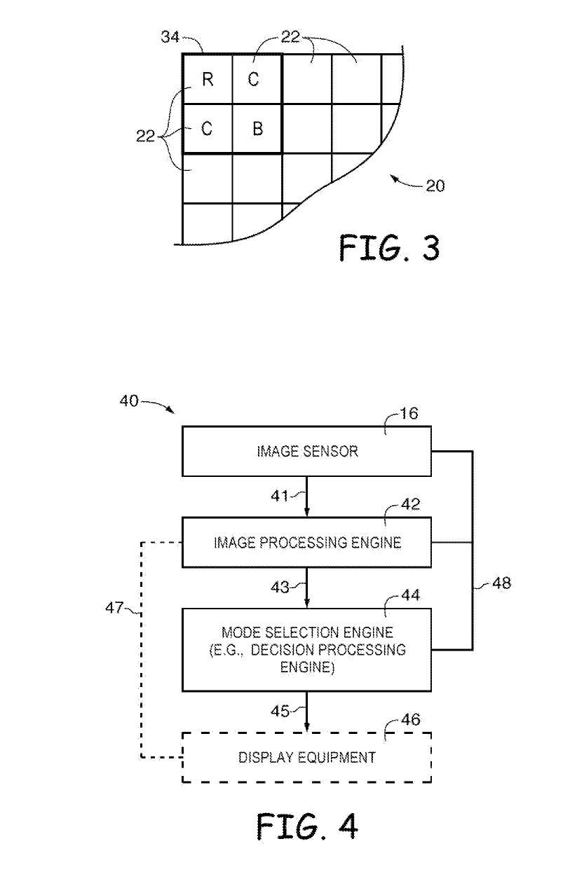

In one suitable arrangement that is sometimes discussed herein as an example, the green pixels in a Bayer pattern are replaced by broadband image pixels as shown in FIG. 3. As shown in FIG. 3, a unit cell 34 of image pixels 22 may be formed from two broadband (C) image pixels that are diagonally opposite one another and adjacent to a red (R) image pixel that is diagonally opposite to a blue (B) image pixel. Unit cell 34 may be repeated across image pixel array 20 to form a mosaic of red, broadband, and blue image pixels 22. In this way, red image pixels may generate red image signals in response to detecting red light, blue image pixels may generate blue image signals in response to detecting blue light, and broadband image pixels may generate broadband image signals in response to detecting any suitable combination of at least two of red light, green light, and blue light (e.g., broadband image pixels 22 may generate broadband image signals in response to red, green, and blue light, may generate broadband image signals in response to red and green light, etc.). Image signals generated by colored (narrowband) image pixels (e.g., in response to one of red light, green light, and blue light) may sometimes be referred to herein as narrowband image signals.

The example of FIG. 3 is merely illustrative. If desired, unit cell 34 may have any desired size, may be rectangular, and may include any number of pixels of any desired color (e.g., unit cell 34 may include four image pixels, eight image pixels, sixteen image pixels, etc.). As an example, the red pixel and/or the blue pixel in unit cell 34 may be replaced with an infrared image pixel, a cyan image pixel, a magenta image pixel, a yellow image pixel, or pixels of any other desired color. In the example of FIG. 3 in which array 20 is formed with unit cell 34, 50% of the pixels in array 20 may be broadband image pixels. However, this is merely illustrative and if desired, array 20 may include any desired number of broadband image pixels 22 (e.g., 75% of the pixels in array 20 may be broadband image pixels, 25% of the pixels in array 20 may be broadband image pixels, etc.).

In some scenarios, imaging devices may use image signals having a broadband response (e.g., broadband image signals) to generate monochrome (greyscale) images of a scene. In Bayer pattern image sensors (i.e., image sensors formed with a color filter elements arranged in a Bayer pattern), the image pixels generate narrowband red, green, and blue image signals using red, green, and blue image pixels. The red, green, and blue image signals can each be demosaicked using separate demosaicking operations to generate a red, green, and blue pixel value at every pixel location in the array. The demosaicked red, green, and blue pixel values can subsequently be combined to produce a broadband response signal that is used to generate the monochrome image. However, performing separate demosaicking operations on the red, green, and blue image signals and combining the demosaicked pixel values can require excessive processing resources and time.

If desired, device 10 may include unit cells 34 for performing imaging operations in a monochrome imaging mode (sometimes referred to herein as a greyscale imaging mode) to generate monochrome (greyscale) images and in a color imaging mode to generate color images to generate color images. Device 10 may switch between the monochrome imaging mode and the color imaging mode during normal operation (e.g., so that device 10 can generate a monochrome image and then subsequently generate a color image, etc.). When operating in the color imaging mode, image sensor 16 may, for example, capture red, blue, and broadband image data and processing circuitry 18 may generate color images using the red, blue, and/or broadband image data. When operating in the monochrome imaging mode, image sensor 16 may capture broadband image data and processing circuitry 18 may generate monochrome images using the broadband image data (e.g., without using the red or blue image data). If desired, image sensor 16 (e.g., column decoder circuitry 28 of FIG. 2) may read out image signals only from broadband image pixels 22 in array 20 when operating in the monochrome imaging mode (e.g., without reading out image signals from colored image pixels 22 in array 20). In this way, device 10 may conserve the processing power and resources that would otherwise be needed to readout narrowband image signals in addition to the broadband image signals.

Because broadband image pixels 22 can capture broadband image signals from a scene, processing circuitry 18 may generate monochrome images without demosaicking narrowband image signals and without combining the demosaicked narrowband image signals (e.g., processing circuitry 18 may generate the monochrome image by performing a single demosaic operation on the captured broadband image signals, whereas Bayer pattern image sensors need to perform three demosaic operations and a combination of the demosaicked signals in order to generate the monochrome image). In this way, image sensor 16 may require less image processing time and fewer image processing resources than Bayer pattern image sensors (e.g., device 10 may produce monochrome images in less time than Bayer pattern image sensors). If desired, device 10 may further reduce the time required to generate monochrome images by only reading out broadband pixels 22 in array 20. Because device 10 requires less processing time to generate monochrome images, device 10 may, if desired, generate images at a higher frame rate than Bayer pattern image sensors (e.g., device 10 may generate monochrome images at twice the frame rate of a Bayer pattern image sensors, at four times the frame rate of Bayer pattern image sensors, etc.).

The fidelity of monochrome and color images generated by device 10 may depend on the number and arrangement of broadband image pixels 22 in array 20. In the example of FIG. 3, broadband image pixels 22 may be formed in every row and every column of array 20 (e.g., half of the image pixels in array 20 may be broadband image pixels), allowing for improved light capture capabilities. Broadband image pixels 22 in array 20 can help increase the signal-to-noise ratio (SNR) of image signals captured by image pixels 22 by gathering additional light in comparison with narrowband image pixels such as green image pixels. Broadband image pixels 22 may particularly improve SNR in low light conditions in which the SNR can sometimes limit the image quality of images. Array 20 having unit cells 40 may thereby generate monochrome and color images having improved SNR, improved luminance channel image fidelity, and improved resolving power relative to images produced by Bayer filter image sensors.

This example is merely illustrative. If desired, array 20 may be formed with any desired number of broadband image pixels 22 (e.g., 10% of the pixels in array 20 may be broadband image pixels, 25% of the pixels in array 20 may be broadband pixels, 50% of the pixels in array 20 may be broadband pixels, more than 50% of the pixels in array 20 may be broadband pixels, etc.). In general, arrays having a greater number of broadband image pixels 22 may have improved spatial sampling in the monochrome image relative to arrays having fewer broadband image pixels 22.

In one suitable arrangement, device 10 may generate broadband image signals for each pixel 22 in array 20 by interpolating the broadband image signals generated by broadband image pixels 22 (e.g., so that broadband image signals are generated for each narrowband pixel in array 20). In another suitable arrangement, processing circuitry 18 may bin the broadband image signals generated by adjacent broadband pixels in array 20 to generate a single binned broadband pixel value for each unit cell 34 in array 20. For example, processing circuitry 18 may perform a linear combination of the broadband image signals generated by each unit cell 34 to generate a single binned broadband image signal for all four image pixels in each unit cell 34. In this way, processing circuitry 18 may increase image processing speed because processing circuitry 18 can generate a single broadband image signal for each unit cell 34 rather than generating separate interpolated broadband image signals for each narrowband pixel in unit cell 34.

If desired, processing circuitry 18 may include user-configurable register circuitry that is used to control the imaging mode with which image sensor 16 generates images. Processing circuitry 18 may instruct image sensor 16 (e.g., using image sensor control signals) to perform imaging operations using a desired imaging mode such as the color imaging mode or the monochrome imaging mode (e.g., based on settings stored at the register circuitry). If desired, processing circuitry 18 may update the imaging mode of image sensor 16 on a frame-by-frame basis. For example, imaging system 16 may capture a first image frame (e.g., a frame of image data) using a first imaging mode. Processing circuitry 18 may include a decision engine that processes the first image frame and determines whether to switch to a second imaging mode. If processing circuitry 18 decides not to switch to the second imaging mode, image sensor 16 may capture an additional image frame using the first imaging mode. If processing circuitry 18 decides to switch to the second imaging mode, processing circuitry 18 may instruct image sensor 16 to capture a second image frame using the second imaging mode.

The amount of power required by device 10 to perform imaging operations may depend on the imaging mode used by image sensor 16. For example, device 10 may require more power to perform color imaging operations than to perform monochrome imaging operations (e.g., because fewer image processing operations are required to generate monochrome images than color images, etc.). In one suitable arrangement which is described herein as an example, image sensor 16 may operate in monochrome imaging mode until processing circuitry 18 detects a triggering event such as motion within the field of view of image sensor 16. In response to detecting the triggering event, processing circuitry 18 may instruct image sensor 16 to switch to color imaging mode so that additional image information and detail is gathered (e.g., color detail associated with the imaged scene). In this way, device 10 may conserve power by operating in monochrome imaging mode until an event that requires additional color image detail occurs. If desired, monochrome imaging mode may be optimized for machine vision (e.g., algorithmic detection of motion), whereas color imaging mode may be optimized for human visual assessment. This example is merely illustrative. If desired, processing circuitry 18 may detect any desired triggering event in the captured image data that triggers a switch between color and monochrome imaging modes. In another suitable arrangement, triggering events that are not captured using image sensor 16 may trigger a switch between color and monochrome imaging modes in image sensor 16. In an example where device 10 is implemented in a security system, activating a silent alarm may trigger a switch between imaging modes, an intruder tripping on a trip wire may trigger a switch between imaging modes, detecting an intruder using an infrared sensor may trigger a switch between imaging modes, etc. If desired, device 10 may notify a user of device 10 that the triggering event has occurred and/or may instruct other devices to switch imaging modes.

FIG. 4 is a diagram of an illustrative imaging system that may perform imaging operations in a monochrome imaging mode and a color imaging mode (e.g., that may switch between imaging modes). As shown in FIG. 4, imaging system 40 may include an image sensor such as image sensor 16 of FIG. 1, image processing circuitry such as image processing engine 42, imaging mode selection circuitry such as mode selection engine 44, and optional display equipment 46. Some or all of imaging system 40 may be formed as a part of device 10 of FIG. 1.

Image sensor 16 may capture image data from a scene (e.g., sometimes referred to herein as raw image data). Image sensor 16 may capture the image data using a selected imaging mode such as monochrome imaging mode or color imaging mode. Image sensor 16 may pass captured image data to image processing engine 42. Image processing engine 42 may be formed as a part of processing circuitry 18 of FIG. 1, as separate circuitry within device 10 (e.g., circuitry formed on a common integrated circuit with image sensor 16, on a common integrated circuit with processing circuitry 18, or on an integrated circuit in device 10 that is separate from image sensor 16 and processing circuitry 18), or as circuitry external to device 10 (e.g., circuitry that is formed remote from device 10).

Image processing engine 42 may perform any desired image processing operations on the raw image data received from image sensor 16 to generate processed images. For example, processing engine 42 may perform demosaic operations, interpolation operations, white balance operations, gamma correction operations, filter operations, chroma demosaicking operations, point filter operations, or any other desired image processing operations on the received image data. Image processing engine 42 may pass the processed images to mode selection engine 44 over path 43. If desired, image processing engine 42 may generate rendered images using the raw image data and/or the processed images (e.g., an image rendered in a standard red, green, blue (sRGB) color space for displaying on a monitor). Image processing engine 42 and may optionally pass the rendered images to display equipment 46 over path 47.

Mode selection engine 44 may be formed as a part of processing circuitry 18 of FIG. 1, as separate circuitry within device 10, as external circuitry that is remote from device 10, as a part of image processing engine 42, or at any other desired location. Mode selection engine 44 may perform additional processing on the processed images. Mode selection engine 44 may, for example, include a decision processing engine for determining whether to instruct image sensor 16 to switch imaging modes. Mode selection engine 44 may compute image statistics associated with received images and may determine whether to switch imaging modes based on the computed image statistics. Mode selection engine 44 may, for example, perform motion detection operations on received images. If desired, mode selection engine 44 may determine scene statistics such as motion score that are indicative of whether motion is present in the imaged scene. If there is excessive motion in the scene, mode selection engine 44 may instruct image sensor 16 to switch to a second imaging mode (e.g., by providing control signals to image sensor 16 and/or processing engine 42 over path 48). Mode selection engine 44 may supply any desired imaging mode settings to image sensor 16 and/or processing engine 42 (e.g., one or more register settings, pixel readout settings, image capture settings, etc.). Image sensor 16 may subsequently capture additional image data using the second imaging mode.

In another suitable arrangement, when mode selection engine 44 identifies excessive motion in the scene, mode selection engine 44 may provide an alert (e.g., a visual, audio, and/or haptic alert) to alert equipment such as display equipment 46 over path 45. Paths 41, 43, 45, 47, and/or 48 may be wired paths or may be wireless paths (e.g., over which wireless signals are conveyed). Display equipment 46 may be formed as a part of device 10 (e.g., as a viewing screen on device 10, as a touch screen on device 10, etc.) or may be formed separately from device 10 (e.g., as a remote monitor in a surveillance system). Display equipment 46 may display rendered images received from image processing engine 42 to a user of imaging system 40. When display 46 receives a visual alert from mode selection engine 44, display 46 may display the visual alert and optionally the rendered image to notify a user of imaging system 40 that there is excessive motion in the imaged scene. The user of imaging system 40 may subsequently view the rendered image to determine whether image sensor 16 should switch imaging modes.

If desired, the user may provide control signals to image sensor 16 (e.g., via a user input device coupled to image sensor 16) that instruct image sensor 16 to capture image data using a different imaging mode. For example, if the user notices an event of interest such as a suspicious person in the rendered images (e.g., after being notified by the displayed visual alert and/or other alerts such as audio or haptic alerts issued by imaging system 50), the user may instruct image sensor 16 to switch imaging modes so that more detailed image data (e.g., color image data) is captured. In examples where imaging system 40 is formed as a part of a surveillance system, image sensor 16 may be operated in a monochrome imaging mode to conserve power. Any motion in the imaged scene may be indicative of a suspicious person or other events of interest. It may, for example, be desirable for image sensor 16 to capture image data using the color imaging mode when a suspicious person or other event of interest is present in the captured image data (e.g., so that additional color data is available to a user of imaging system 40 for visual inspection). The user of imaging system 40 and/or mode selection engine 44 may thereby provide control signals to image sensor 16 that instruct image sensor 16 to capture image data using the color imaging mode. In this way, imaging system 40 may gather color images of a scene when an event of interest occurs in the imaged scene while conserving power (e.g., by using monochrome imaging mode) when the imaged scene is static (e.g., while the imaged scene is free from motion or other objects of interest). By forming unit cells 34 of broadband image pixels on image sensor 16, imaging system 40 may perform both monochrome and color imaging operations using a single pixel array 20 and may generate monochrome and color images having improved image fidelity and with improved speed relative to Bayer pattern image sensors.

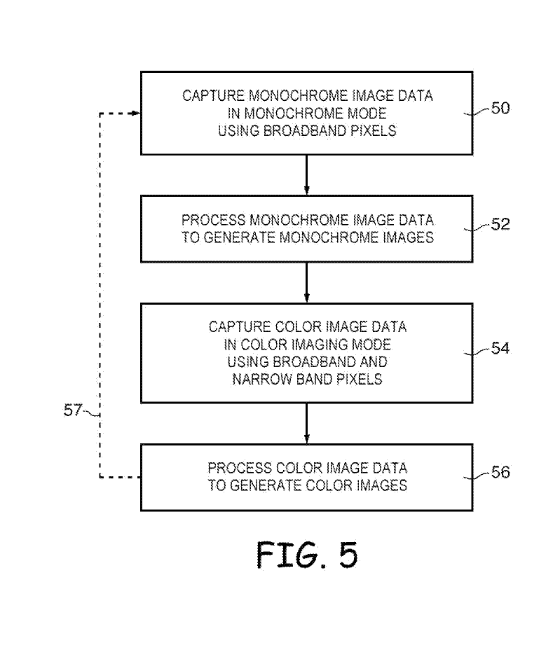

FIG. 5 is a flow chart of illustrative steps that may be performed by imaging system 40 to generate monochrome images and color images (e.g., using a single pixel array 20 having both broadband and narrowband pixels 22).

At step 50, image sensor 16 may perform monochrome imaging operations (e.g., in monochrome imaging mode). Broadband pixels 22 in image sensor 16 may capture monochrome image data from a scene. Image sensor 16 may convey the captured monochrome image data to processing circuitry 18 (e.g., image processing engine 42 and/or decision processing engine 44).

At step 52, processing circuitry 18 may process the monochrome image data to generate monochrome images. The monochrome images may be further processed to determine whether image sensor 16 should switch imaging modes, may be displayed on a display such as display equipment 46, may be sent to other processing circuitry, etc.

At step 54, image sensor 16 may perform color imaging operations (e.g., in color imaging mode). If desired, image sensor 16 may perform color imaging operations after receiving control signals from processing circuitry 18 that instruct image sensor 16 to switch from the monochrome imaging mode to the color imaging mode. Broadband pixels and narrowband pixels 22 in image sensor 16 may capture color image data from the scene. Image sensor 16 may convey the captured color image data to processing circuitry 18 (e.g., processing engine 42 and/or decision engine 44).

At step 56, processing circuitry 18 may process the color image data to generate color images. The color images may be further processed to determine whether image sensor 16 should switch imaging modes, may be displayed on display equipment 46, may be sent to other circuitry, etc. If desired, processing may loop back to step 50 to perform additional monochrome imaging operations with image sensor 16. For example, image sensor 16 may receive control signals instructing image sensor 16 to switch from color imaging mode to monochrome imaging mode.

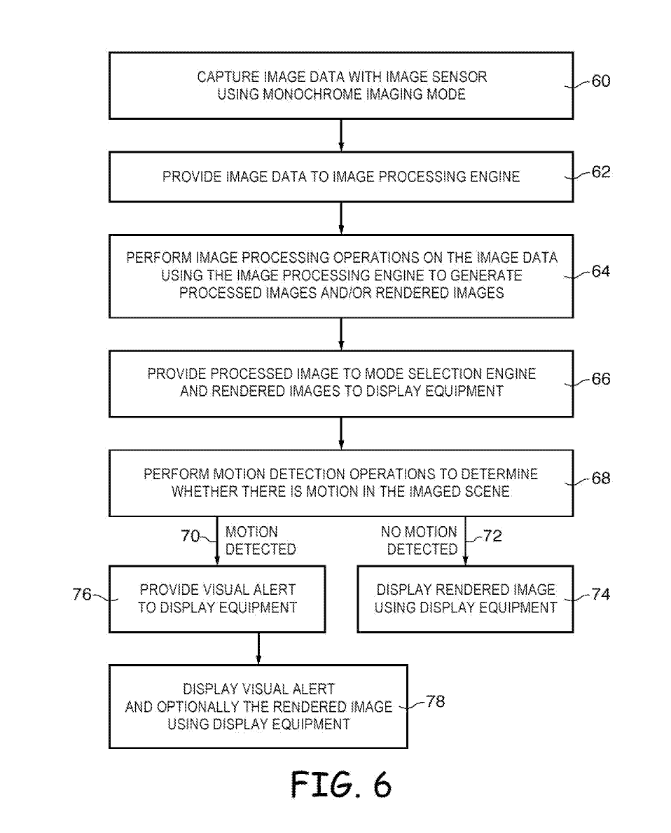

If desired, a user may provide input signals to imaging system 40 to instruct image sensor 16 to switch imaging modes (e.g., to instruct image sensor 16 to switch from monochrome imaging mode to color imaging mode). FIG. 6 is a flow chart of illustrative steps that may be performed by imaging system 40 to provide visual alerts to a user of imaging system 40 so that the user may determine whether to switch from monochrome imaging mode to color imaging mode. The steps of FIG. 6 may, for example, be performed by a surveillance imaging system to alert a user of the surveillance system of a suspicious person or event.

At step 60, image sensor 16 may capture image data using monochrome imaging mode (e.g., image sensor 16 may capture monochrome image data). If desired, broadband pixels 22 in image sensor 16 may be read out and readout operations for narrowband pixels 22 in image sensor 16 may be omitted (e.g., to conserve power required for pixel readout).

At step 62, image sensor 16 may provide the captured image data to image processing engine 42.

At step 64, image processing engine 42 may generate processed images and/or rendered images by performing image processing operations on the received image data. Engine 42 may perform any desired image processing operations on the received image data. For example, engine 42 may generate monochrome images by demosaicking the monochrome image data. Processing engine 42 may generate rendered images based on the received image data for display using display equipment 46.

At step 66, image processing engine 42 may provide the processed images to mode selection engine 44 and may optionally provide the rendered images to display equipment 46.

At step 68, mode selection engine 44 may perform motion detection operations on the processed images to determine whether there is motion in the imaged scene. For example, mode selection engine 44 may determine whether there is excessive motion in the scene (e.g., whether there is sufficient motion in the imaged scene to warrant notifying the user of imaging system 40). If desired, engine 44 may compute image statistics associated with the processed images (e.g., motion statistics). For example, mode selection engine 44 may compute a motion score or any other desired metric for characterizing motion in the processed images (e.g., by comparing multiple frames of processed image data). If engine 44 does not detect motion in the processed images (e.g., if engine 44 detects insufficient motion or no motion in the processed images), engine 44 may determine that a user of imaging system 40 need not be alerted and processing may proceed to step 74 as shown by path 72.

At step 74, display 46 may display the rendered image to a user (e.g., without any visual alerts or notifications). If engine 44 detects motion in the imaged scene (e.g., if a computed motion score is greater than a motion score threshold value), processing may proceed to step 76 as shown by path 70. At step 76, engine 44 may provide a visual alert to display equipment 46. If desired, engine 44 may provide an audio and/or haptic alert to display equipment 46 and/or other user notification equipment coupled to imaging system 50.

At step 78, display equipment 46 may display the visual alert and the rendered image to notify the user of imaging system 40 that motion was detected in the scene. The user of imaging system 40 may subsequently examine the rendered image displayed by equipment 46 to determine whether to instruct image sensor 16 to generate color image data (e.g., using the color imaging mode). In another suitable arrangement, mode selection engine 44 may provide a text-based alert such as an email alert or text message to a user of imaging system 40 notifying the user that motion was detected by the imaging system (e.g., using networking circuitry coupled to engine 44).

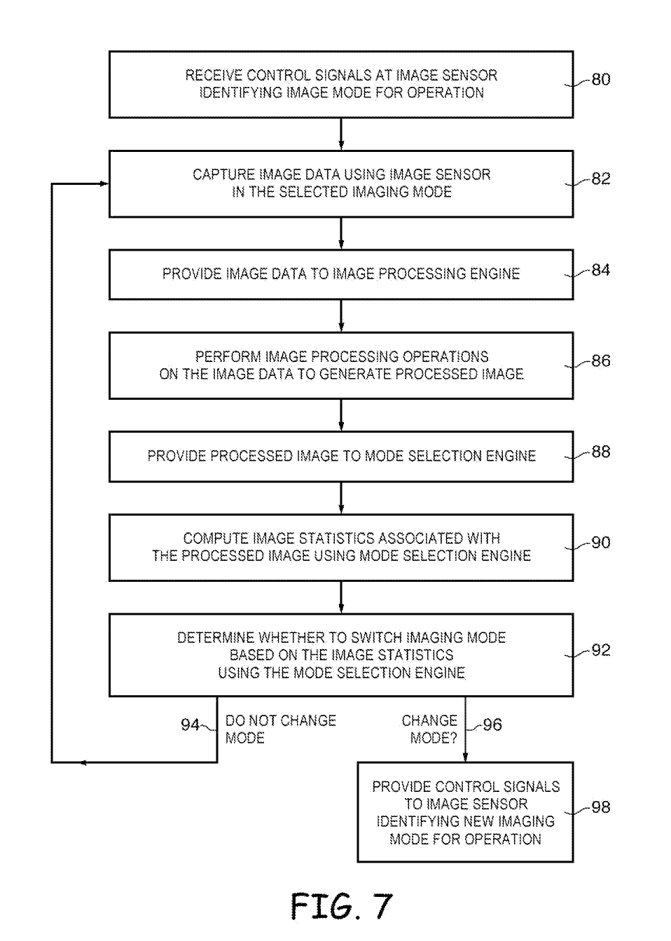

If desired, imaging system 40 may switch between monochrome and color imaging modes autonomously (e.g., without input from a user of imaging system 40). FIG. 7 is a flow chart of illustrative steps that may be performed by imaging system 40 of FIG. 4 for autonomously determining whether to switch between imaging modes.

At step 80, image sensor 16 may receive control signals identifying an imaging mode for capturing images. For example, image sensor 16 may receive control signals from processing circuitry 18 (FIG. 1) and/or from mode selection engine 44 identifying an imaging mode for imaging operations.

At step 82, image sensor 16 may capture image data using the selected imaging mode. Image sensor 16 may provide the captured image data to image processing engine 42 (step 84).

At step 86, image processing engine 42 may perform any desired image processing operations on the image data to generate processed images. Image processing engine 42 may provide the processed images to mode selection engine 44 (step 88).

At step 90, mode selection engine 44 may compute image statistics associated with the processed images. For example, mode selection engine 44 may perform motion detection operations on the processed images. If desired, mode selection engine 44 may compute a motion score or any other desired metric for characterizing motion in the processed images (e.g., by comparing multiple frames of processed image data).

At step 92, mode selection engine 44 may determine whether to switch imaging modes based on the computed image statistics. If desired, mode selection engine 44 may determine that image sensor 16 is to switch imaging modes if there is excessive motion in the processed images (e.g., if the computed motion score exceeds a motion score threshold value). As an example, mode selection engine 44 may decide to switch from monochrome imaging mode to color imaging mode if there is excessive motion in the processed images. As another example, mode selection engine 44 may decide to switch from color imaging mode to monochrome imaging mode if there is insufficient motion in the processed images (e.g., if there is no motion in the processed images after a predetermined amount of time).

If mode selection engine 44 determines that image sensor 16 should not change imaging modes, processing may loop back to step 82 via path 94 to capture additional image data using the current imaging mode. If mode selection engine 44 determines that image sensor 16 should change imaging modes, processing may proceed to step 98 via path 96.

At step 98, mode selection engine 44 may provide control signals to image sensor 16 that instruct image sensor 16 to perform imaging operations in a different imaging mode. For example, mode selection engine 44 may provide control signals to image sensor 16 to instruct image sensor 16 to switch from monochrome imaging mode to color imaging mode. If desired, the control signals provided to image sensor 16 may include any other desired control signals such as control signals that specify one or more readout settings for image sensor 16. For example, image sensor 16 may supply register settings to image sensor register circuitry formed on processing circuitry 18 in response to determining whether to switch imaging modes. In this way, imaging system 40 may switch between color imaging mode (in which greater image detail is captured) and monochrome imaging mode (in which less image detail is captured but which requires less power and processing resources) without any input from a user of imaging system 40 (e.g., imaging system 40 may operate autonomously or semi-autonomously with a user's input).

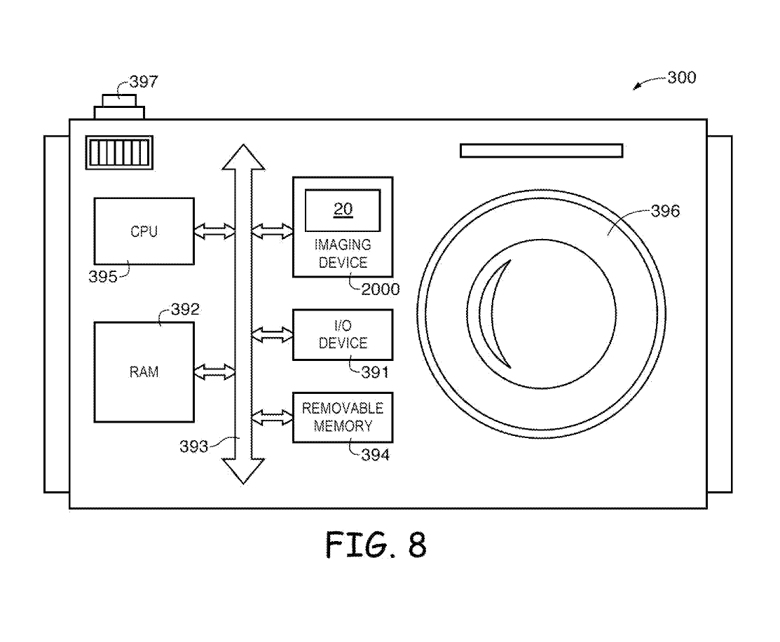

FIG. 8 shows in simplified form a typical processor system 300, such as a digital camera, which includes an imaging device 2000 (e.g., an imaging device 2000 such as imaging system 40 (e.g., device 10) of FIGS. 1-7 employing broadband color filters and the techniques for performing imaging operations described above). The processor system 300 is exemplary of a system having digital circuits that could include imaging device 2000. Without being limiting, such a system could include a computer system, still or video camera system, scanner, machine vision, vehicle navigation, video phone, surveillance system, auto focus system, star tracker system, motion detection system, image stabilization system, and other systems employing an imaging device.

The processor system 300 generally includes a lens 396 for focusing an image on pixel array 20 of device 2000 when a shutter release button 397 is pressed, central processing unit (CPU) 395, such as a microprocessor which controls camera and one or more image flow functions, which communicates with one or more input/output (I/O) devices 391 over a bus 393. Imaging device 2000 also communicates with the CPU 395 over bus 393. The system 300 also includes random access memory (RAM) 392 and can include removable memory 394, such as flash memory, which also communicates with CPU 395 over the bus 393. Imaging device 2000 may be combined with the CPU, with or without memory storage on a single integrated circuit or on a different chip. Although bus 393 is illustrated as a single bus, it may be one or more busses or bridges or other communication paths used to interconnect the system components.

Various embodiments have been described illustrating image sensors having broadband image pixels for generating monochrome images and color images.

An image sensor may have an array of image sensor pixels and processing circuitry. The array may receive light of a first color, light of a second color that is different from the first color, and light of a third color that is different from the first and second color (e.g., the array may receive red, blue, and green light). The array may include a first group (set) of image sensor pixels such as red image sensor pixels that generate first image signals such as red image signals in response to detecting (capturing) red light. The array may include a second group of image sensor pixels such as blue image sensor pixels that generate second image signals such as blue image signals in response to detecting blue light. The array may include a group of broadband image sensor pixels that generate broadband image signals in response to detecting light of at least two of the first, second color, and third colors (e.g., in response to capturing at least two of red light, blue light, and green light light).

The imaging system may be operable in a monochrome imaging mode in which the imaging system generates monochrome images based on the broadband image signals and in a color imaging mode in which the imaging system generates color images based on the first, second, and broadband image signals. If desired, pixel readout circuitry coupled to the pixel array may read out the broadband image signals from the broadband image sensor pixels in the monochrome imaging mode and may read out the broadband image signals from the broadband image pixels, the first image signals from the first group of image pixels, and the second image signals from the second group of image signals in the color imaging mode. If desired, the imaging mode selection circuitry may compute image statistics and may perform motion detection operations on the monochrome image (e.g., to determine whether motion is present in the monochrome image). If the imaging mode selection circuitry determines that motion is present in the monochrome image, the imaging mode selection circuitry may provide a visual alert to display equipment and/or may provide updated image sensor register settings to image sensor register circuitry coupled to the image sensor. For example, the processing circuitry may provide first register settings to the register circuitry in the monochrome imaging mode and may provide second register settings to the register circuitry in response to determining that motion is present in the captured monochrome image.

If desired, the imaging system may further include a central processing unit, memory, input-output circuitry, and a lens that focuses light (e.g., at least red, blue, and green light) onto the array of image sensor pixels.

The foregoing is merely illustrative of the principles of this invention and various modifications can be made by those skilled in the art without departing from the scope and spirit of the invention. The foregoing embodiments may be implemented individually or in any combination.

What is claimed is:

1. An imaging system, comprising:
processing circuitry; and
an array of image sensor pixels configured to receive light of a first color, light of a second color that is different from the first color, and light of a third color that is different from the first and second colors, wherein the array of image sensor pixels comprises:
a first group of image sensor pixels configured to generate first image signals in response to detecting the light of the first color;
a second group of image sensor pixels configured to generate second image signals in response to detecting the light of the second color; and
a third group of image sensor pixels configured to generate third image signals in response to detecting light of at least two of the first color, the second color, and the third color, wherein the processing circuitry is configured to generate a monochrome image based on the third image signals.

2. The imaging system defined in claim 1, wherein the processing circuitry is further configured to generate a color image based on the first, second, and third image signals.

3. The imaging system defined in claim 2, wherein the array of image sensor pixels is arranged in rows and columns and wherein each row and each column of the array of image sensor pixels comprises at least one image sensor pixel from the third group of image sensor pixels.

4. The imaging system defined in claim 3, wherein at least half of the image sensor pixels in the array of image sensor pixels are selected from the third group of image sensor pixels.

5. The imaging system defined in claim 2, wherein the imaging system is operable in a monochrome imaging mode and a color imaging mode, wherein the processing circuitry is configured to generate the color image in the color imaging mode, and wherein the processing circuitry is configured to generate the monochrome image in the monochrome imaging mode.

6. The imaging system defined in claim 5, wherein the imaging system further comprises:
readout circuitry coupled to the array of image sensor pixels, wherein the readout circuitry is configured to read out the third image signals from the third group of image sensor pixels in the monochrome imaging mode.

7. The imaging system defined in claim 6, wherein the readout circuitry is configured to read out the first image signals from the first group of image sensor pixels, the second image signals from the second group of image sensor pixels, and the third image signals from the third group of image sensor pixels in the color imaging mode.

8. The imaging system defined in claim 5, further comprising:
imaging mode selection circuitry configured to compute image statistics associated with the monochrome image in the monochrome imaging mode.

9. The imaging system defined in claim 8, wherein the imaging mode selection circuitry is further configured to perform motion detection operations on the monochrome image based on the computed image statistics.

10. The imaging system defined in claim 1, wherein the third group of image sensor pixels comprises broadband image pixels configured to generate the third image signals in response to detecting at least two of red light, blue light, and green light.

11. A method of generating images using an imaging system, wherein the imaging system comprises processing circuitry and an array of image sensor pixels, wherein the array of image sensor pixels comprises first, second, and third sets of image sensor pixels, the method comprising:
with the first set of image sensor pixels, generating first image signals in response to capturing light of a first color;
with the second set of image sensor pixels, generating second image signals in response to capturing light of a second color that is different from the first color;
with the third set of image sensor pixels, generating broadband image signals in response to capturing light of at least two of the first color, the second color, and a third color that is different from the first and second colors; and
with the processing circuitry, generating a greyscale image based on the third image signals.

12. The method defined in claim 11, wherein the imaging system is operable in a color imaging mode and a monochrome imaging mode, the method further comprising:
with the processing circuitry, generating the greyscale image in the monochrome imaging mode; and
with the processing circuitry, generating a color image based on the first, second, and third image signals in the color imaging mode.

13. The method defined in claim 12, further comprising:
with the processing circuitry, performing motion detection operations on the greyscale image to determine whether motion is present in the greyscale image.

14. The method defined in claim 13, further comprising:
with the processing circuitry, generating the color image in response to determining that motion is present in the greyscale image.

15. The method defined in claim 14, wherein the imaging system further comprises display equipment, the method further comprising:
with the processing circuitry, providing a visual alert to the display equipment in response to determining that motion is present in the greyscale image; and
with the display equipment, displaying the visual alert.

16. The method defined in claim 13, wherein the imaging system further comprises image sensor register circuitry, the method further comprising:
with the processing circuitry, providing first register settings to the image sensor register circuitry in the monochrome imaging mode; and
with the processing circuitry, providing second register settings to the image sensor register circuitry in response to determining that motion is present in the greyscale image.

17. The method defined in claim 13, wherein performing the motion detection operations comprises:
computing a motion score associated with the greyscale image; and
comparing the computed motion score to a motion score threshold value.

18. The method defined in claim 12, wherein the imaging system further comprises pixel readout circuitry, the method further comprising:
with the pixel readout circuitry, reading out only the third image signals from the array of image sensor pixels in the monochrome imaging mode.

19. A system, comprising:
a central processing unit;
memory;
input-output circuitry; and
an imaging device operable in a monochrome imaging mode and in a color imaging mode, wherein the imaging device comprises:
an array of image pixels, wherein the array of image sensor pixels comprises red image pixels, blue image pixels, and broadband image pixels;
a lens that focuses at least red light, blue light, and green light onto the array, wherein the red image sensor pixels are configured to generate red image signals in response to capturing the red light, wherein the blue image sensor pixels are configured to generate blue image signals in response to capturing the blue light, and wherein the broadband image sensor pixels are configured to generate broadband image signals in response to capturing at least two of the red light, the blue light, and the green light; and
processing circuitry configured to generate a monochrome image based on the broadband image signals in the monochrome imaging mode.

20. The system defined in claim 19, wherein the processing circuitry is further configured to generate a color image based on the red, blue, and broadband image signals in the color imaging mode.
